(19) United States
(12) Patent Application Publication
(10) Pub. No.: US 2009/0055857 A1
(43) Pub. Date: Feb. 26, 2009

(54) VIDEO CHANNEL CURATION

(75) Inventor: Scott Gatz, San Francisco, CA (US)

Correspondence Address: Weaver Austin Villeneuve & Sampson - Yahoo!, P.O. BOX 70250, OAKLAND, CA, 94612-0250, US

(73) Assignee: Yahoo! INC., Sunnyvale, CA (US)

(21) Appl. No.: 11/842,843

(22) Filed: Aug. 21, 2007

(51) Int. Cl. H04N 7/10

(52) U.S. Cl. 725/32

(57) ABSTRACT

According to one embodiment of the present invention, a schedule of videos is received from a curator, wherein the curator is involved in displaying videos on a web page and the schedule is a list of videos to be displayed on the web page. One or more advertisements are matched to the schedule of videos, wherein the matching is based at least partially upon the content of videos within the schedule of videos or information about the schedule of videos. Then a video stream containing videos from the schedule of videos is integrated into the web page, along with the one or more advertisements.

### BACKGROUND OF THE INVENTION

1. Field of the Invention

The present invention relates to Internet web sites. More particularly, the present invention relates to curating video channels.

2. Description of the Related Art

A “blog” is an Internet web log that an author uses to display relevant entries in chronological order and often provides areas for readers to post feedback to the entries. It has become a very popular forum to display news or commentary.

Web sites devoted to displaying video files, such as YouTube™ and Yahoo™ Videos have also gained in popularity. On these sites, content providers post copies of video files and users are able to download these file, typically for free, and play the videos using web browser plug-ins or stand-alone video player software.

### SUMMARY OF THE INVENTION

According to one embodiment of the present invention, a schedule of videos is received from a curator, wherein the curator is involved in displaying videos on a web page and the schedule is a list of videos to be displayed on the web page. One or more advertisements are matched to the schedule of videos, wherein the matching is based at least partially upon the content of videos within the schedule of videos or information about the schedule of videos. Then a video stream containing videos from the schedule of videos is integrated into the web page, along with the one or more advertisements.

### BRIEF DESCRIPTION OF THE DRAWINGS

FIG. 1 is a diagram illustrating an example of a video player embedded into a web page in accordance with an embodiment of the present invention.

FIG. 2 is a flow diagram illustrating a method in accordance with an embodiment of the present invention.

FIG. 3 is an exemplary network diagram illustrating some of the platforms that may be employed with various embodiments of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

According to various embodiments of the present invention, users are able to act as curators for a video “channel” of their own design. The curator, who is involved in the displaying of videos on the page, such as the operator or user of a web site, may select a group of videos he wishes to display to visitors. This video stream may then be integrated into the web page. While web pages may have general advertising accompanying them, and video distribution web sites also have advertising on them, the present invention allows the curator to derive revenue from the compilation of the videos.

The curator may create a schedule of videos selected from one or more content providers. Targeted advertising may then be placed on the web page accompanying the video display. This may include advertising placed next to or on the same page as a video display. Alternatively, the advertising may be in the form of video or audio advertisements placed within the video stream itself (e.g., commercials). This advertising may be targeted based on the content of the video schedule.

It should also be noted that the video stream and advertisements may be integrated into other media in addition to the web pages. For example, the video stream may be downloaded to the user's computer to be played by a stand-alone video player, or may be sent to a portable device such as an MP3 player or mobile phone.

The targeting of the advertising may be accomplished in many ways. One way is for the curator to label the video channel he has created in a certain way. For example, if the curator selects videos depicting clips of baseball games, the curator may label the channel as the “baseball channel.” Advertising may then be targeted based on which advertisers are likely to target consumers interested in baseball. In situations where the channel is not labeled by the curator or is otherwise hard to define, metadata from the video clips or the content provider may be utilized to approximate a genre or other categorization for the videos. Other alternatives for determining the how to match advertising to the videos include crawling the web to search for other places where the videos are embedded, as well as performing various investigations of the audience of the videos (e.g., demographic targeting of viewers of the videos, retrieval of user profiles for users of the video, and behavioral tracking of viewers including, for example, which other videos the viewers have played). For example, if many users who play videos from the schedule of videos have profiles listing baseball as a hobby, there is a reasonable likelihood that the schedule of videos at hand is also related to baseball, or at least to sports in general. Additionally, if many users who play videos from the schedule of videos also play videos from a schedule of videos categorized as “Baseball”, there is a reasonable likelihood that the schedule of videos at hand is also related to baseball, or at least to sports in general.

In addition to focusing on factors involving the videos, the targeting of the advertising may also involve focusing on the advertisements. Metadata from the advertising or the advertising provider may be utilized to aid in the matching of advertising to videos. Other alternatives for aiding in the matching of advertising to videos include crawling the web to search for other places where the advertising has been displayed, as well as performing various investigations of the audience of the advertising (e.g., demographic targeting of viewers of the advertising, retrieval of user profiles for users of the video, and behavioral tracking of viewers, e.g., which other advertisements the viewers have seen).

Revenue from the targeted advertising may be shared between the curator and the content providers of the video in the channel.

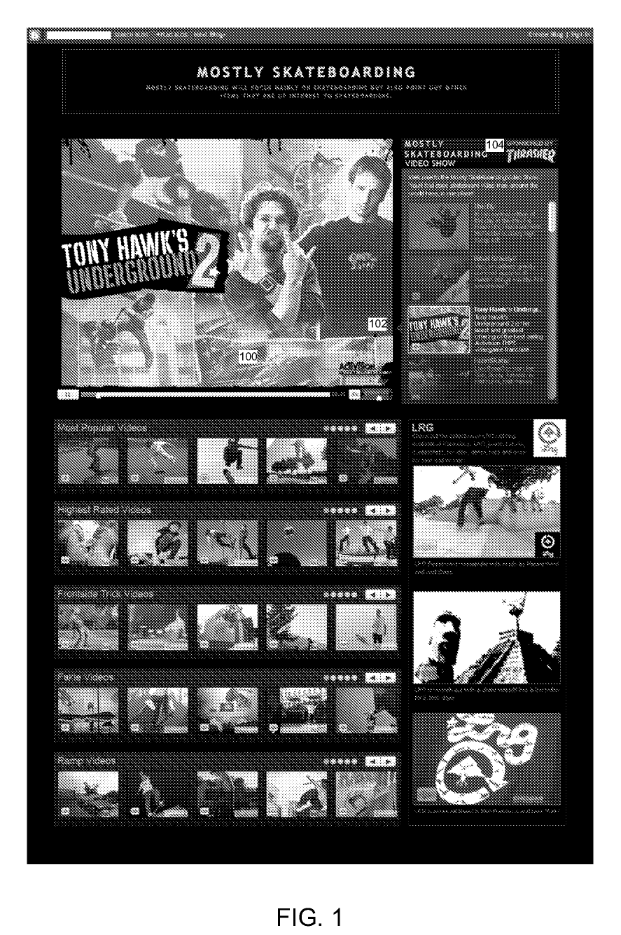

FIG. 1 is a diagram illustrating an example of a video player embedded into a web page (specifically, a blog) in accordance with an embodiment of the present invention. In this example, the blog is geared towards skateboarders. A video player 100 embedded in the blog plays a schedule of videos. An advertisement 102 is embedded into the video itself. A schedule of videos is presented 104 from which the displayed video is retrieved.

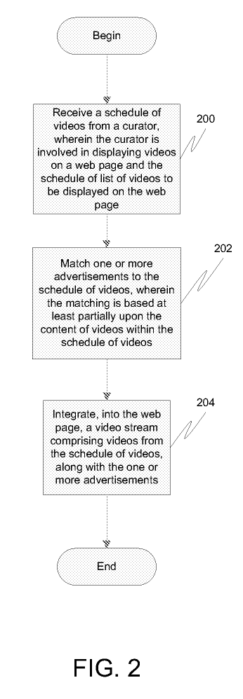

FIG. 2 is a flow diagram illustrating a method in accordance with an embodiment of the present invention. At 200, a schedule of videos is received from a curator, wherein the curator is involved in displaying videos on a web page and the schedule is a list of videos to be displayed on the web page. At 202, one or more advertisements are matched to the schedule of videos, wherein the matching is based at least partially upon the content of videos within the schedule of videos and/or other information relating to the schedule of videos. This information may constitute many different things, such as, for example, a category for the schedule, the ordering of the schedule, the type of users that access the schedule, etc. A category for the schedule of videos may be determined. This category may be determined in many different ways. An indication of a category for the schedule of videos may be received from the user. Alternatively, metadata corresponding to videos within the schedule of videos may be retrieved and analyzed. Alternatively, the system may crawl other web sites on which videos within the schedule of videos reside and information may be gathered that is helpful in determining a category for the schedule of videos. Alternatively, one or more users who have viewed a video in the schedule of videos may be tracked. This tracking information may then be used to retrieve user profiles indicating hobbies or other information that might be helpful in categorizing the videos. Likewise, this tracking information may be used to track web-based behavioral patterns for the one or more users, such as which other video streams the users have played. Identified categories of other played video streams may be helpful in determining a category for the schedule of videos at hand.

At 204, a video stream is integrated within the web page, wherein the video stream comprises videos from the schedule of videos along with the one or more advertisements. The integrating may include embedding a video player within the web page such that the video player is customized for the web page (e.g., has a unique “skin”). It should also be noted that the video stream can be any type of video stream, including a live video stream. This integration also may or may not include embedding the advertising within the video stream. For example, implementations are contemplated wherein the advertising is integrated into the web page without being integrated into the video stream itself (e.g., banner advertising along the top of the video player). For example, ads included elsewhere on the webpage could display a relevant targeted ad and dynamically update as different videos are played within the channel.

As will be understood, each of the processes depicted in FIG. 2 may be performed by a module of software operating on one or more computing devices having one or more interfaces and executed by one or more processors.

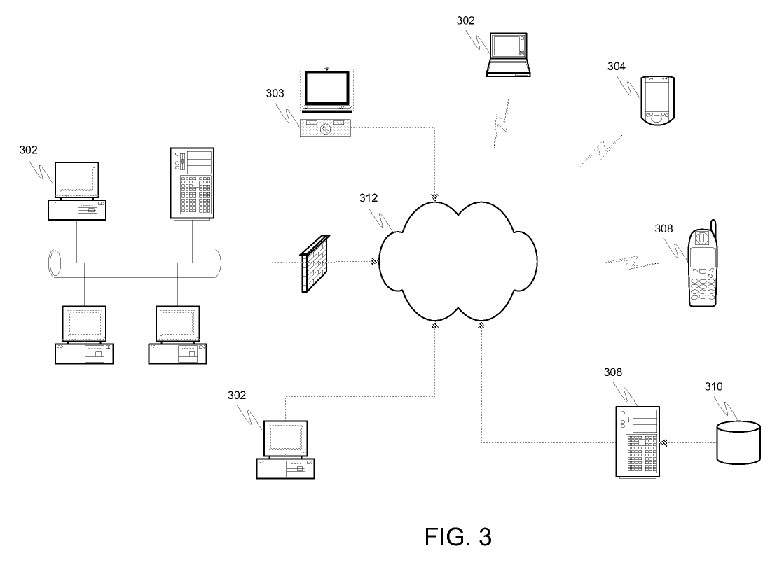

It should also be noted that embodiments of the present invention may be implemented on any computing platform and in any network topology in which presentation of video is a useful functionality. For example and as illustrated in FIG. 3, implementations are contemplated in which the invention is implemented in a network containing personal computers 302, media computing platforms 303 (e.g., cable and satellite set top boxes with navigation and recording capabilities (e.g., Tivo)), handheld computing devices (e.g., PDAs) 304, cell phones 306, or any other type of portable communication platform. Users of these devices may navigate the network, and this information may be collected by server 308, which may be understood to represent one or more computing devices working in concert. Server 308 (or any of a variety of computing platforms) may include a memory, a processor, and a communications component and may then utilize the various techniques described above to determine advertisements to display to the user based on the information. The processor of the server 308 may be configured to run, for example, all of the processes described in FIG. 1. Server 308 may be coupled to a database 310, which stores the information. Applications may be resident on such devices, e.g., as part of a browser or other application, or be served up from a remote site, e.g., in a Web page (also represented by server 308 and database 310). The invention may also be practiced in a wide variety of network environments (represented by network 312), e.g., TCP/IP-based networks, telecommunications networks, wireless networks, etc. The invention may also be tangibly embodied in one or more program storage devices as a series of instructions readable by a computer (i.e., in a computer readable medium).

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method comprising:
receiving a schedule of videos from a curator, wherein the curator is involved in displaying videos on a web page and the schedule is a list of videos to be displayed on the web page;
matching one or more advertisements to the schedule of videos, wherein the matching is based at least partially upon the content of one or more videos within the schedule of videos or information about the schedule of videos; and
integrating, a video stream containing videos from the schedule of videos into the web page, along with the one or more advertisements.

2. The method of claim 1, wherein the web page is a blog.

3. The method of claim 1, further comprising:
receiving an indication of a category for the schedule of videos from the user; and
wherein the one or more advertisements are matched using the indication of a category for the schedule of videos.

4. The method of claim 1, further comprising:
retrieving metadata corresponding to videos within the schedule of videos; and
wherein the one or more advertisements are matched using the metadata.

5. The method of claim 1, further comprising:
retrieving metadata corresponding to the one or more advertisements; and
wherein the one or more advertisements are matched using the metadata.

6. The method of claim 1, further comprising:
crawling other web sites on which videos within the schedule of videos reside;
gathering information from the other web sites that is helpful in determining a category for the schedule of videos; and
wherein the one or more advertisements are matched using the information that is helpful in determining a category for the schedule of videos.

7. The method of claim 1, further comprising:
crawling other web sites on which the one or more advertisements have been played;
gathering information from the other web sites that is helpful in determining in what context the one or more advertisements should be displayed; and
wherein the one or more advertisements are matched using the information that is helpful in determining in what context the one or more advertisements should be displayed.

8. The method of claim 1, further comprising:
tracking one or more users who have viewed a video in the schedule of videos;
retrieving user profiles for the one or more users; and
wherein the one or more advertisements are matched using information from the user profiles.

9. The method of claim 1, further comprising:
tracking one or more users who have viewed a video in the schedule of videos;
tracking web-based behavioral patterns for the one or more users; and
wherein the one or more advertisements are matched using the web-based behavioral patterns.

10. The method of claim 9, wherein the web-based behavioral patterns include playing of video streams corresponding to other schedules of videos, wherein the video streams corresponding to other schedules of videos have identified categories.

11. The method of claim 1, wherein revenue generated from the advertising is shared between the curator and content providers of videos in the schedule of videos.

12. A method comprising:
displaying a web page, wherein the web page comprises an embedded video stream playing videos from a schedule of videos from a curator and wherein the web page further comprises one or more advertisements matched to the schedule of videos, wherein the matching is based at least partially upon the content of one or more of the videos within the schedule of videos or information about the schedule of videos.

13. An apparatus comprising:
means for receiving a schedule of videos from a curator, wherein the curator is involved in displaying videos on a web page and the schedule is a list of videos to be displayed on the web page;
means for matching one or more advertisements to the schedule of videos, wherein the matching is based at least partially upon the content of one or more of the videos within the schedule of videos or information about the schedule of videos; and
means for integrating, a video stream containing videos from the schedule of videos into the web page, along with the one or more advertisements.

14. The apparatus of claim 13, further comprising:
means for receiving an indication of a category for the schedule of videos from the user; and
wherein the one or more advertisements are matched using the indication of a category for the schedule of videos.

15. The apparatus of claim 13, further comprising:
means for retrieving metadata corresponding to videos within the schedule of videos; and
wherein the one or more advertisements are matched using the metadata.

16. The apparatus of claim 13, further comprising:
means for retrieving metadata corresponding to the one or more advertisements; and
wherein the one or more advertisements are matched using the metadata.

17. The apparatus of claim 13, further comprising:
means for crawling other web sites on which videos within the schedule of videos reside;
means for gathering information from the other web sites that is helpful in determining a category for the schedule of videos; and
wherein the one or more advertisements are matched using the information that is helpful in determining a category for the schedule of videos.

18. The apparatus of claim 13, further comprising:
means for crawling other web sites on which the one or more advertisements have been played;
means for gathering information from the other web sites that is helpful in determining in what context the one or more advertisements should be displayed; and
wherein the one or more advertisements are matched using the information that is helpful in determining in what context the one or more advertisements should be displayed.

19. The apparatus of claim 13, further comprising:
means for tracking one or more users who have viewed a video in the schedule of videos;
means for retrieving user profiles for the one or more users; and
wherein the one or more advertisements are matched using information from the user profiles.

20. The apparatus of claim 13, further comprising:
means for tracking one or more users who have viewed a video in the schedule of videos;
means for tracking web-based behavioral patterns for the one or more users; and
wherein the one or more advertisements are matched using the web-based behavioral patterns.

21. The apparatus of claim 20, wherein the web-based behavioral patterns include playing of video streams corresponding to other schedules of videos, wherein the video streams corresponding to other schedules of videos have identified categories.

22. A server comprising:
an interface; and
a processor configured to:
receive a schedule of videos from a curator, wherein the curator is involved in displaying videos on a web page and the schedule is a list of videos to be displayed on the web page;
match one or more advertisements to the schedule of videos, wherein the matching is based at least partially upon the content of one or more videos within the schedule of videos or information about the schedule of videos; and
integrate, a video stream containing videos from the schedule of videos into the web page, along with the one or more advertisements.
